(19) United States
(12) Patent Application Publication
(10) Pub. No.: US 2025/0016669 A1
(43) Pub. Date: Jan. 9, 2025

(54) METHOD AND APPARATUS FOR HANDLING A LADN SERVICE AREA IN A WIRELESS COMMUNICATION SYSTEM

(71) Applicant: Samsung Electronics Co., Ltd., Suwon-si (KR)

(72) Inventors: Ashok Kumar NAYAK, Bangalore (IN); Lalith KUMAR, Bangalore (IN); Danish Ehsan HASHMI, Bangalore (IN); Sangjun MOON, Suwon-si (KR)

(21) Appl. No.: 18/764,763

(22) Filed: Jul. 5, 2024

(30) Foreign Application Priority Data
Jul. 7, 2023 (IN) 202341045951
Jun. 26, 2024 (IN) 2023 41045951

(51) Int. Cl. H04W 48/18; H04W 8/22; H04W 60/04

(52) U.S. Cl. CPC H04W 48/18; H04W 8/22; H04W 60/04

(57) ABSTRACT

The disclosure relates to a 5G or 6G communication system for supporting a higher data transmission rate. A method for handling a local area data network (LADN) service area in a wireless network is provided. The method performed by an access and mobility management function (AMF) entity in a wireless communication system includes receiving, from a user equipment (UE), capability information indicating that the UE supports a local area data network (LADN) per data network name (DNN) and single network slice selection assistance information (S-NSSAI), identifying an LADN service area for a DNN and an S-NSSAI, and transmitting, to the UE, information on the DNN, information on the S-NSSAI, and information on the LADN service area.

### CROSSREFERENCE TO RELATED APPLICATION(S)

This application is based on and claims priority under 35 U.S.C. § 119 (a) of an Indian Provisional patent application No. 20/234,1045951, filed on Jul. 7, 2023, in the Indian Patent Office, and of an Indian Complete patent application No. 202341045951, filed on Jun. 26, 2024, in the Indian Patent Office, the disclosure of each of which is incorporated by reference herein in its entirety.

### BACKGROUND

### 1. Field

The disclosure relates to Network Slicing in a 3^{rd} Generation Partnership Project (3GPP). More particularly, the disclosure relates to systems and methods for ensuring in a fifth generation (5G) system that an Access Mobility Function (AMF) entity and a Session Management Function (SMF) entity along with an User Equipment (UE) is correctly handling a Local Area Data Network (LADN) information provisioning and Protocol Data unit (PDU) session for LADN per Data Network Name (DNN) and Single-Network Slice Selection Assistance Information (S-NSSAI).

### 2. Description of Related Art

5^{th} generation (5G) mobile communication technologies define broad frequency bands such that high transmission rates and new services are possible, and can be implemented not only in “Sub 6 gigahertz (GHz)” bands, such as 3.5 GHz, but also in “Above 6 GHz” bands referred to as millimeter-wave (mmWave) including 28 GHz and 39 GHz. In addition, it has been considered to implement 6^{th} generation (6G) mobile communication technologies (referred to as Beyond 5G systems (5GSs)) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Aspects of the disclosure are to address at least the above-mentioned problems and/or disadvantages and to provide at least the advantages described below. Accordingly, an aspect of the disclosure is to provide a systems and methods for ensuring in the 5G system that the Access Mobility Function and Session Management Function along with User Equipment is correctly handling the LADN information provisioning and Protocol Data Session for LADN per DNN & S-NSSAI.

Another aspect of the disclosure is to provide that the AMF entity, while providing LADN information, checks whether the slice of LADN information is present in the allowed NSSAI or partially allowed NSSAI. If the slice is present in the allowed NSSAI or the partially allowed NSSAI then only the AMF provides the LADN information.

Another aspect of the disclosure is to provide that if the UE is in overlapping area between partial slice support area and LADN service area or any combination of them then, the UE shall give precedence to partial slice support area before LADN area for evaluation.

Additional aspects will be set forth in part in the description which following and, in part, will be apparent from the description, or may be learned by practice of the presented embodiments.

In accordance with an aspect of the disclosure, a method for handling a LADN service area in a wireless network is provided. The method includes determining, by an Access and Mobility Management Function (AMF) entity, whether a Single Network Slice Selection Assistance Information (S-NSSAI) is included in a Partially Allowed Network Slice Selection Assistance Information (NSSAI), and providing, by the AMF entity, a LADN information associated with the S-NSSAI from at least one of the Partially Allowed NSSAI and an Allowed NSSAI.

In an embodiment, the method includes providing, by the AMF entity, the LADN information associated with the S-NSSAI from at least one of the Partially Allowed NSSAI and the Allowed NSSAI that includes receiving, by the AMF entity, a registration request message from a UE, determining, by the AMF entity, a capability support of the UE based on the registration request message, determining, by the AMF entity, that the LADN information is available for the UE from at least one of based on a local configuration at the AMF entity and the AMF entity receives as part of subscription data from an UDM, and providing, by the AMF entity, the LADN information associated with the S-NSSAI from the Partially Allowed NSSAI in response to determining that the LADN information is available for the UE from at least one of based on the local configuration at the AMF entity and the AMF entity receives as part of subscription data from an UDM.

In an embodiment, the method includes configuring, by the AMF entity, the LADN information per DNN and S-NSSAI from at least one the Partially Allowed NSSAI and the Allowed NSSAI. Further, the method includes sending, by the AMF entity, the configured LADN information per DNN and S-NSSAI from at least one of the Partially Allowed NSSAI and the Allowed NSSAI to the UE.

In an embodiment, the method includes updating, by the AMF entity, the LADN information for the S-NSSAI wherein the respective S-NSSAI is removed from at least one of the Partially Allowed NSSAI, and the allowed NSSAI.

In an embodiment, the method includes allocating, by the AMF entity, the LADN information and a TAI list associated with the S-NSSAI in the partially allowed NSSAI independently.

In accordance with another aspect of the disclosure, a method for handling a Local Area Data Network (LADN) service in a wireless network is provided. The method includes determining, by a User Equipment, that a S-NSSAI is present in at least one of a Partially Allowed Network Slice Selection Assistance Information (NSSAI), and an allowed NSSAI and obtaining, by the UE, a LADN information for the S-NSSAI based on the determination.

In an embodiment, the method includes obtaining, by the UE, the LADN information from at least one of the Partially Allowed NSSAI and the Allowed NSSAI includes obtaining, by the UE, a capability support of the UE, wherein the capability support corresponds to receive the LADN information, sending, by the UE, a registration request message comprising the capability support to an AMF entity, and obtaining, by the UE, the LADN information associated with the S-NSSAI from at least one of the Partially Allowed NSSAI and the Allowed NSSAI based on the capability support of the UE.

In an embodiment, the method includes updating, by the UE, the LADN information when the S-NSSAI is removed from at least one of the Partially Allowed NSSAI, and the allowed NSSAI. In an embodiment, the updating is done at locally at the UE or receiving an explicit indication from the AMF entity.

In accordance with another aspect of the disclosure a method for handling a LADN service in a wireless network is provided. The method includes detecting, by a UE, at least one overlapping area between a LADN service area and a partial network slice support area, giving precedence, by the UE, an evaluation of the partial network slice support area over an evaluation of the LADN service area configured per DNN and S-NSSAI based on the detection and evaluating, by the UE, the partial network slice support area before evaluating the LADN information configured per DNN and S-NSSAI for the at least one overlapping area.

In accordance with another aspect of the disclosure, a method for handling a LADN service area in a wireless network is provided. The method includes detecting, by a SMF entity, at least one overlapping area between a LADN service area configured per DNN and S-NSSAI, and a Partial Network Slice Support Area, giving precedence, by the SMF entity, to an evaluation of the Partial Network Slice Support Area over an evaluation of the LADN service area configured per DNN and S-NSSAI in response to the at least one overlapping area and evaluating, by the SMF entity, the Partial Network Slice Support Area before the evaluation of the LADN service area configured per DNN and S-NSSAI in case of at least one overlapping area.

In accordance with another aspect of the disclosure, an AMF entity is provided. The AMF entity includes a processor, memory, and a LADN information controller coupled with the processor and the memory, configured to determine that a S-NSSAI is included in a Partially Allowed NSSAI, and provide a LADN information associated with the S-NSSAI from at least one of the Partially Allowed NSSAI and an Allowed NSSAI.

In accordance with another aspect of the disclosure, a UE is provided. The UE includes a processor, memory, and a LADN information controller coupled with the processor and the memory, configured to determine that an S-NSSAI is present in at least one of a Partially Allowed NSSAI, and an allowed NSSAI, and obtain a LADN information for the S-NSSAI based on the determination.

In accordance with another aspect of the disclosure, a UE is provided. The UE includes a processor, memory, and a LADN information controller coupled with the processor and the memory, configured to detect at least one overlapping area between a LADN service area and a partial network slice support area, give precedence to an evaluation of the partial network slice support area over an evaluation of the LADN service area configured per DNN and S-NSSAI based on the detection, and evaluate the partial network slice support area before evaluating the LADN information configured per DNN and S-NSSAI for the at least one overlapping area.

In accordance with another aspect of the disclosure, a SMF entity is provided. The SMF entity includes a processor, memory, and a LADN information controller coupled with the processor and the memory, configured to detect at least one overlapping area between a LADN service area configured per DNN and S-NSSAI, and a Partial Network Slice Support Area, give precedence to an evaluation of the Partial Network Slice Support Area over an evaluation of the LADN service area configured per DNN and S-NSSAI in response to the at least one overlapping area, and evaluate the Partial Network Slice Support Area before the evaluation of the LADN service area configured per DNN and S-NSSAI in case of at least one overlapping area.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 depicts the LADN service area provisioning to the UE without considering Partially Allowed NSSAI in a wireless network according to the related art;

FIG. 2 depicts the LADN service area provisioning to the UE considering Partially Allowed NSSAI in the wireless network according to an embodiment of the disclosure;

FIG. 3 shows various hardware components of an AMF entity according to an embodiment of the disclosure;

FIG. 4 shows various hardware components of a UE according to an embodiment of the disclosure;

FIG. 5 shows various hardware components of an SMF entity according to an embodiment of the disclosure;

FIG. 6 is a flow chart illustrating a method, implemented by the AMF entity, for handling the LADN service area in a wireless network according to an embodiment of the disclosure;

FIG. 7 is a flow chart illustrating a method, implemented by the UE, for handling the LADN service area in a wireless network according to an embodiment of the disclosure;

FIG. 8 is a flow chart illustrating a method, implemented by the UE, for handling the LADN service area in a wireless network, when the UE detects at least one overlapping area between a LADN service area and a partial network slice support area according to an embodiment of the disclosure;

FIG. 9 is a flow chart illustrating a method, implemented by the SMF entity, for handling the LADN service area in a wireless network according to an embodiment of the disclosure.

FIG. 10 shows various hardware components of a user equipment (UE) according to an embodiment of the disclosure; and

FIG. 11 shows various hardware components of a network entity according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure, the word “˜˜˜” is used herein to mean “serving as an example, instance, or illustration.” Any embodiment or implementation of the present subject matter described herein as “˜˜˜” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the disclosure. The following description is, therefore, not to be taken in a limiting sense.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the operations required for understanding of aspects of the embodiments as disclosed herein. Furthermore, in terms of the construction of the device, one or more components of the device may have been represented in the drawings by conventional symbols, and the drawings may show only those specific details that are pertinent to understanding the various embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the various embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

The access to a Data Network via a Protocol Data Unit (PDU) Session for a LADN is only available in a specific LADN service area. The LADN service area is a set of Tracking Areas. The LADN is a service provided by a serving Public Land Mobile Network (PLMN). A UE is configured to know if a particular DNN is a LADN DNN, or it gets this information from an AMF entity during registration and a UE configuration update procedure. The UE initiates a PDU session related to the LADN DNN only when it is inside of the LADN service area. Similarly, an SMF entity ensures that a downlink packet is not provided to the UE when the UE is outside of the LADN service area. To know whether the UE is inside or outside of the LADN service area, the SMF entity subscribes to a “UE mobility event notification” service provided by an AMF entity for reporting of UE presence in Area of Interest by providing the LADN DNN. The details are provided in technical specification (TS) 23.501 Clause 5.6.5. 3GPP Release 18 extended this LADN concept from per DNN to per DNN & S-NSSAI. The details are provided in TS 23.501 Clause 5.6.5a.

Issue 1: The 3GPP also introduced the concept of “Partial Network Slice Support” which means a slice is not supported in all the TAs of registration area (RA), rather only supported in few TAs of the RA. In this case, the standard has provided the provision for the AMF entity to provide the Partially Allowed NSSAI along with Allowed NSSAI during registration and the UE configuration update procedure. The Partially Allowed NSSAI will contain the S-NSSAIs with information of TAs where these slices are supported. The UE can directly trigger the PDU when it moves to a TA where the slice is supported. For the established PDU, if the UE is moved out of the TAs where the slice is Partially supported then the PDUs shall be deactivated which means only the user plane resources shall be deactivated but PDU sessions will be kept. The UE and the network shall not exchange any uplink and downlink data (both user plane and control plane (CP) data as part of a Non-access stratum (NAS) message) if the UE is out of Partially Allowed NSSAI.

Similarly, another concept “Network Slice Area of Service (NS-AoS)” has been introduced. In this case, the operator may configure resources for the Network Slices in the cells of TAs where the Network Slices are to be available, and in areas of the TAs, where the network slice is defined to be not available, the cells are configured with zero resources. The AMF entity receives from an operations, administration, and maintenance (OAM) entity, the information on availability of a network slice when the granularity is smaller than TA, i.e., if the NS-AOS includes TAs where the network slice is not available in some cells of the TA. During registration and the UE configuration update procedure, the AMF provides this slice location availability information (NS-AoS) information to the UE. In this case, when the UE moves out of NS-AOS then the existing PDU session is kept, but all the resources of the PDU sessions shall be deactivated. The UE and the network shall not exchange any uplink and downlink data (both user plane and CP data as part of NAS message) if the UE is out of NS-AoS.

The 3GPP has provided a solution for configuring the LADN per DNN & S-NSSAI. If the UE has indicated its capability to support LADN per DNN & S-NSSAI, then the AMF provides LADN service area if it is locally configured at the AMF or received as part of the subscription data from the UDM entity. But at present, during registration procedure or the UE configuration update procedure, the AMF entity only considers the S-NSSAI presence in Allowed NSSAI, but does not check whether the S-NSSAI associated with LADN per DNN & S-NSSAI is in Partially Allowed NSSAI for the UE before providing the LADN service area. If the S-NSSAI is in Partially Allowed NSSAI, the UE can directly trigger the PDU while in the TA, where the S-NSSAI is supported, but it may happen that the LADN service area per DNN and S-NSSAI (of those respective S-NSSAI) the same TA is restricted which means LADN feature does not work as expected or per requirement.

In an example, LADN service area per DNN1 & S-NSSAI-1: TA1, TA5, TA6 and for DNN2 & S-NSSAI-2: TA2, TA5 (configured at AMF locally or received from UDM as part of subscription)

Requested S-NSSAI: S-NSSAI-1, S-NSSAI-2, S-NSSAI-3,

Allowed NSSAI: S-NSSAI-2, S-NSSAI-3,

Registration Area: TA1,TA2,TA5, and

Partially Allowed NSSAI: S-NSSAI-1 with information that this slice is supported in TA1 and TA2.

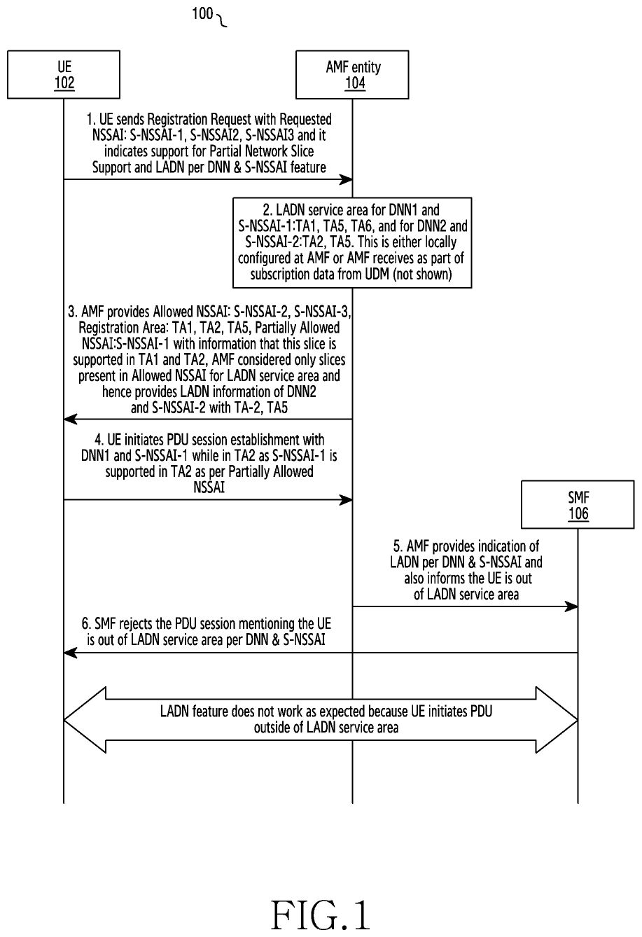

FIG. 1 depicts the LADN service area provisioning to the UE without considering Partially Allowed NSSAI in a wireless network (100) according to the related art.
Issue 1: As depicted in FIG. 1, if the AMF entity (104) does not consider the Partially Allowed NSSAI and does not provide the LADN service area, then the UE (102) can trigger the PDU for DNN1 and S-NSSAI-1 while in TA2 but as per LADN service area UE should not trigger PDU if it is not in TA1, TA5, and TA6. It means the LADN feature does not work as expected.
Issue 2: The SMF entity (106) knows the UE location whether it is inside or outside of the LADN service area configured per DNN and S-NSSAI and hence it does not send any downlink packet including CP-DATA if the UE (102) is outside of LADN service area. If the S-NSSAI is present in Partially Allowed NSSAI, but the UE (102) is moved outside of the TA, where the S-NSSAI is not supported, then in this case, the SMF entity (106) does not send any downlink packets including CP-DATA.

Similarly, if the S-NSSAI is in Allowed NSSAI, but the same S-NSSAI is not supported in all the cells of TA and the UE (102) is moved to a cell where the S-NSSAI is not supported, then also the SMF entity (106) does not send any downlink packets including CP-DATA. For these two cases, the SMF entity (106) identifies the location of the UE (100) and then decides the action of not sending any downlink packet.

But in a case, when there is an overlapping of LADN service area configured per DNN & S-NSSAI and the partial network slice support area (Partial network slice support because of Partially Allowed NSSAI and NS-AoS concept), the evaluation criteria for the UE (102) and the SMF entity (106) need to be defined. If this is not addressed and if both features are configured together, then the feature will not work as expected which means the UE (102) may send the uplink packet including CP-DATA though it should not have been sent or the SMF entity (106) may send the downlink packet though it should not have been sent or vice-versa.

At operation 1, the UE (102) sends the registration request with requested NSSAI: S-NSSAI-1, S-NSSAI2, S-NSSAI3 and it indicates support for Partial Network Slice Support and LADN per DNN & S-NSSAI feature. At operation 2, the AMF entity (104) determines the LADN service area for DNN1 and S-NSSAI-1: TA1, TA5, TA6, and for DNN2 and S-NSSAI-2: TA2, TA5. This is either locally configured at the AMF entity (104) or the AMF entity (104) receives as part of subscription data from an UDM (not shown).

At operation 3, the AMF entity (104) provides the Allowed NSSAI: S-NSSAI-2, S-NSSAI-3, Registration Area: TA1, TA2, TA5, Partially Allowed NSSAI: S-NSSAI-1 with information that this slice is supported in TA1 and TA2. The AMF entity (104) considered only slices present in Allowed NSSAI for LADN service area and hence provides LADN information of DNN2 and S-NSSAI-2 with TA-2, TA5.

At operation 4, the UE (102) initiates the PDU session establishment with the DNN1 and S-NSSAI-1 while in TA2 as S-NSSAI-1 is supported in TA2 as per Partially Allowed NSSAI. At operation 5, the AMF entity (104) provides indication of LADN per DNN & S-NSSAI and also informs the UE (102) is out of LADN service area. At operation 6, the SMF entity (106) rejects the PDU session mentioning the UE (102) is out of LADN service area per DNN and S-NSSAI. The LADN feature does not work as expected because the UE (102) initiates PDU outside of LADN service area.

Hence, there is a need in the art for solutions which will overcome the above mentioned drawback(s), among others.

The above information is presented as background information only to assist with an understanding of the disclosure. No determination has been made, and no assertion is made, as to whether any of the above might be applicable as prior art with regard to the disclosure.

The embodiments herein achieve a method for handling a LADN service area in a wireless network. The method includes determining, by an Access and Mobility Management Function (AMF) entity, whether a Single Network Slice Selection Assistance Information (S-NSSAI) is included in a Partially Allowed Network Slice Selection Assistance Information (NSSAI). Further, the method includes providing, by the AMF entity, a LADN information associated with the S-NSSAI from at least one of: the Partially Allowed NSSAI and an Allowed NSSAI.

In various embodiments, the methods can be used for ensuring in the 5G system that the Access Mobility Function and Session Management Function along with User Equipment is correctly handling the LADN service area provisioning and Protocol Data Session for LADN per DNN & S-NSSAI.

If the slices which are not present either in Allowed NSSAI or Partially Allowed NSSAI then, the UE cannot trigger any PDU session including PDU for the LADN DNN. Hence there is no point for the AMF entity to send the LADN information for those slices which are not applicable for the UE. Hence, the AMF entity filters out from the available LADN information and only sends information for the slice which is present in the UE's Allowed NSSAI and the Partially Allowed NSSAI.

As the user moves, for example, from one area to another, it's very evident that the UE may find itself in an overlapping area of partial slice support area and LADN service area. In this case, there is a need for the UE to be made aware of which area to be evaluated first so that when an operator enables both the feature, the UE can take suitable action. Hence it was suggested that the UE shall evaluate partial slice support area over the LADN area. Thus, results in optimizing and saving the resources of core network, radio and UE resources.

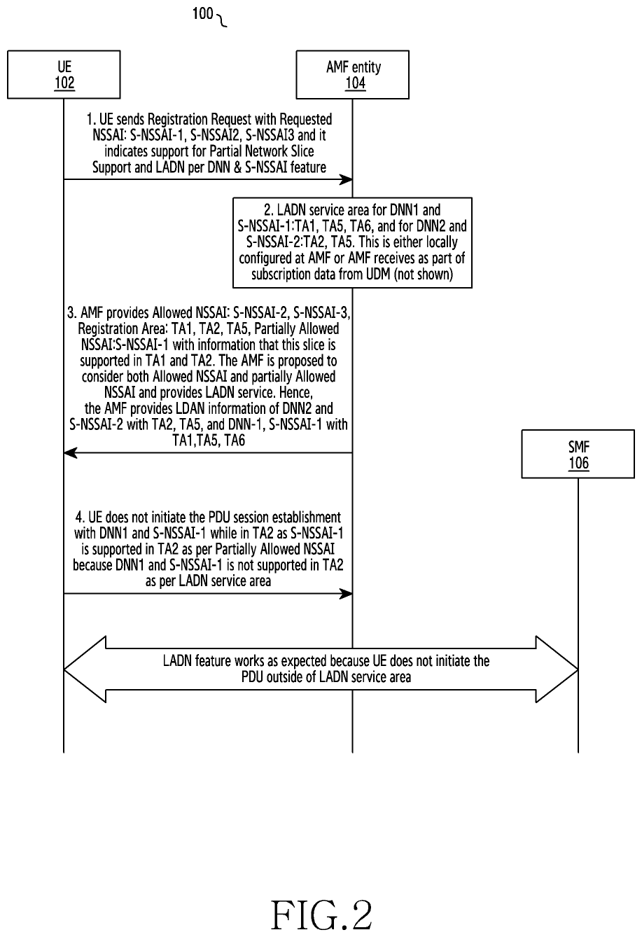

Referring now to the drawings, and more particularly to FIGS. 2 to 9, where similar reference characters denote corresponding features consistently throughout the figures, there are shown at least one embodiment.

FIG. 2 depicts the LADN service area provisioning to the UE considering Partially Allowed NSSAI in the wireless network (100) according to an embodiment of the disclosure.

The UE (102) can be, for example, but not limited to a laptop, a desktop computer, a notebook, a Device-to-Device (D2D) device, a vehicle to everything (V2X) device, a smartphone, a foldable phone, a smart TV, a tablet, a server, an IoT device, a VST device, an Augmented Reality (AR) device, a Mixed Reality (MR) device, a Virtual Reality (VR) device, an immersive device, and a metaverse device.

At operation 1, the UE (102) sends the registration request with requested NSSAI: S-NSSAI-1, S-NSSAI2, S-NSSAI3 and it indicates support for Partial Network Slice Support and LADN per DNN & S-NSSAI feature. At operation 2, the AMF entity (104) determines the LADN service area for DNN1 and S-NSSAI-1: TA1, TA5, TA6, and for DNN2 and S-NSSAI-2: TA2, TA5. This is either locally configured at the AMF entity (104) or the AMF entity (104) receives as part of subscription data from an UDM (not shown).

At operation 3, the AMF entity (104) provides Allowed NSSAI: S-NSSAI-2, S-NSSAI-3, Registration Area: TA1, TA2, TA5, Partially Allowed NSSAI: S-NSSAI-1 with information that this slice is supported in TA1 and TA2. The AMF entity (104) is proposed to consider both Allowed NSSAI and partially Allowed NSSAI and provides LADN service. Hence, the AMF entity (104) provides LDAN information of DNN2 and S-NSSAI-2 with TA2, TA5, and DNN-1, S-NSSAI-1 with TA1, TA5, TA6.

At operation 4, the UE (102) does not initiate the PDU session establishment with DNN1 and S-NSSAI-1 while in TA2 as S-NSSAI-1 is supported in TA2 as per Partially Allowed NSSAI but DNN1 and S-NSSAI-1 is not supported in TA2 as per LADN service area. The LADN feature works as expected because the UE (102) does not initiate the PDU outside of LADN service area.

As explained in the problem statement, if the AMF entity (104) provides the LADN service area per DNN and S-NSSAI without checking whether the S-NSSAI is in Partially Allowed NSSAI then it is leading to a situation where the UE (102) can directly trigger a PDU because slice support in that TA present in Partially Allowed NSSAI but as per LADN service area it is restricted. Hence it is proposed that if the S-NSSAI is added Partially Allowed NSSAI, then only the AMF entity (104) provides the LADN service area of those respective S-NSSAI (as depicted in FIG. 2). It is also proposed that whenever the S-NSSAI is removed from the Partially Allowed NSSAI, then the AMF entity (104) provides the updated LADN information (empty LADN information if all the slices part of LADN information is removed wither from Allowed NSSAI and/or Partially Allowed NSSAI or by removing of those DNN, S-NSSAI along with LADN service area of those associated S-NSSAI which was removed either from Allowed NSSAI or Partially Allowed NSSAI) so that the UE (100) can delete or update the already stored LADN information of those respective S-NSSAI. It is also proposed that the UE (100) may implicitly delete the stored LADN information locally if the associated S-NSSAI is removed from Partially Allowed NSSAI.

In an embodiment, as explained in the problem statement in the case overlapping of LADN service area configured per DNN & S-NSSAI and the partial network slice support area, the SMF entity (106) needs to evaluate enforcement of the service area. Hence it is proposed that if the SMF entity (106) has overlapping areas between the LADN service area configured per DNN & S-NSSAI, and the Partial network slice support area, or any combination of them, then the evaluation of Partial network slice support area take precedence over the evaluation of LADN service area configured per DNN & S-NSSAI.

In an embodiment, the evaluation of Partial network slice support area will be performed before the evaluation of LADN service area configured per DNN & S-NSSAI, if the SMF entity (106) has overlapping areas between the LADN service area configured per DNN & S-NSSAI and the partial network slice support area.

In another embodiment, the evaluation of LADN service area configured per DNN & S-NSSAI takes precedence over the evaluation of Partial network slice support area.

The evaluation of LADN service area configured per DNN & S-NSSAI will be performed before the evaluation of Partial network slice support area, if the SMF entity (106) has overlapping areas between the LADN service area configured per DNN & S-NSSAI and the partial network slice support area.

If the UE (102) has overlapping areas between LADN service area configured per DNN & S-NSSAI, Partial network slice support area, or any combination of them, then the evaluation of Partial network slice support area takes precedence over the evaluation of LADN service area configured per DNN & S-NSSAI.

In an embodiment, the evaluation of Partial network slice support area will be performed before the evaluation of LADN service area configured per DNN & S-NSSAI, if the UE (102) has overlapping areas between the LADN service area configured per DNN & S-NSSAI and the partial network slice support area.

In another embodiment, the evaluation of LADN service area configured per DNN & S-NSSAI takes precedence over the evaluation of Partial network slice support area.

In an embodiment, the evaluation of LADN service area configured per DNN & S-NSSAI will be performed before the evaluation of Partial network slice support area, if the UE (102) has overlapping areas between LADN service area configured per DNN & S-NSSAI and the partial network slice support area.

In another embodiment, if the S-NSSAI is added either to Allowed NSSAI or Partially Allowed NSSAI then only AMF entity (104) provides the LADN service area as part of registration procedure or UE configuration update procedure.

When the S-NSSAI is removed either from Allowed NSSAI or Partially Allowed NSSAI, then the AMF entity (104) provides the empty LADN information so that the UE (102) can delete the already stored LADN information.

In an embodiment, the AMF entity (104) can send UE configuration update command message with re-registration required flag, when the UE triggers registration procedure. The AMF entity (104) does not include the LADN information IE, due to which the UE will delete any stored LADN information at the UE (102) or the AMF entity (104) will send the updated LADN information IE which does not include the S-NSSAI which is removed from Allowed NSSAI list or Partially Allowed NSSAI list IE this will result in the UE also removing the respective LADN information of the S-NSSAIs (which have been removed from Allowed NSSAI or Partially Allowed NSSAI list IE).

The UE may implicitly delete the stored LADN information if the associated S-NSSAI is removed from either Allowed NSSAI or Partially Allowed NSSAI.

In an embodiment, if the SMF entity (106) has overlapping areas between LADN service area configured per DNN & S-NSSAI, Partial network slice support area, or any combination of them, then the evaluation of Partial network slice support area takes precedence over the evaluation of LADN service area configured per DNN & S-NSSAI or the evaluation of LADN service area configured per DNN & S-NSSAI take precedence over the evaluation of Partial network slice support area.

In another embodiment, the evaluation of Partial network slice support area will be performed before the evaluation of LADN service area configured per DNN & S-NSSAI or the evaluation of LADN service area configured per DNN & S-NSSAI will be performed before the evaluation of Partial network slice support area if the SMF entity (106) has overlapping areas between LADN service area configured per DNN & S-NSSAI and the partial network slice support area.

In yet another embodiment, if the UE has overlapping areas between LADN service area configured per DNN & S-NSSAI, Partial network slice support area, or any combination of them, then the evaluation of Partial network slice support area take precedence over the evaluation of LADN service area configured per DNN & S-NSSAI or the evaluation of LADN service area configured per DNN & S-NSSAI take precedence over the evaluation of Partial network slice support area.

In an embodiment, the evaluation of Partial network slice support area will be performed before the evaluation of LADN service area configured per DNN & S-NSSAI or the evaluation of LADN service area configured per DNN & S-NSSAI will be performed before the evaluation of Partial network slice support area, if the UE has overlapping areas between LADN service area configured per DNN & S-NSSAI and the partial network slice support area.

In an embodiment, if the AMF entity (104) receives any PDU session from on TA for which LADN service area is not allowed, then irrespective of whether the AMF had configured the LADN service area earlier to the UE or not, the AMF entity (104) can reject the PDU session instead of ending to SMF entity (106) indication UE is out of LADN service area and the SMF entity (106) rejects the PDU session. This includes the LADN service area per DNN or per DNN & S-NSSAI.

In a network deployment when both LADN per DNN & S-NSSAI and Partial Slice support is configured, then both the AMF entity (104) and the SMF entity (106) should be configured with same policy either to keep the PDU session or to release the PDU session when the UE is not inside the LADN service area per DNN & S-NSSAI, in the TA where slice is not supported as part of Partially Allowed NSSAI, in the cell where slice is not supported as part of NS-AoS.

The term LADN information and Extended LADN information are used interchangeably in this document where LADN information generally refers to LADN per DNN and service area where as Extended LADN information refers to LADN per DNN & S-NSSAI and service area.

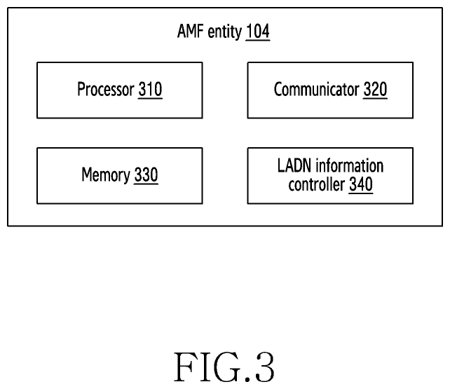

FIG. 3 shows various hardware components of the AMF entity (104) according to an embodiment of the disclosure.

In an embodiment, the AMF entity (104) includes a processor (310), a communicator (320), memory (330) and a LADN information controller (340). The processor (310) is coupled with the communicator (320), the memory (330) and the LADN information controller (340).

The LADN information controller (340) determines that the S-NSSAI is included in the Partially Allowed NSSAI. Further, the LADN information controller (340) provides the LADN information associated with the S-NSSAI from at least one of: the Partially Allowed NSSAI and the Allowed NSSAI.

The LADN information controller (340) receives the registration request message from the UE (102). Further, the LADN information controller (340) determines the capability support of the UE (102) based on the registration request message. Further, the LADN information controller (340) determines that the LADN information is available for the UE from at least one of: based on the local configuration at the AMF entity (104) and the AMF entity (104) receives as part of subscription data from an UDM (not shown). Further, the LADN information controller (340) provides the LADN information associated with the S-NSSAI from the Partially Allowed NSSAI in response to determining that the LADN information is available for the UE (102) from at least one of: based on the local configuration at the AMF entity (104) and the AMF entity (104) receives as part of subscription data from the UDM.

In another embodiment, the LADN information controller (340) configures the LADN information per DNN and S-NSSAI from at least one: the Partially Allowed NSSAI and the Allowed NSSAI. Further, the LADN information controller (340) sends the configured LADN information per DNN and S-NSSAI from at least one of: the Partially Allowed NSSAI and the Allowed NSSAI to the UE.

In yet another embodiment, the LADN information controller (340) updates the LADN information for the S-NSSAI wherein the respective S-NSSAI is removed from at least one of: the Partially Allowed NSSAI, and the allowed NSSAI.

In still another embodiment, the LADN information controller (340) allocates the LADN information and the TA1 list associated with the S-NSSAI in the partially allowed NSSAI independently.

The LADN information controller (340) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (310) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (310) may include multiple cores and is configured to execute the instructions stored in the memory (330).

The processor (310) is configured to execute instructions stored in the memory (330) and to perform various processes. The communicator (320) is configured for communicating internally between internal hardware components and with external devices via one or more networks. The memory (330) also stores instructions to be executed by the processor (310). The memory (330) may, for example, include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. The memory (330) may, in some examples, be considered a non-transitory storage medium. The term “non-transitory” may indicate that the storage medium is not embodied in a carrier wave or a propagated signal. However, the term “non-transitory” should not be interpreted that the memory (330) is non-movable. In certain examples, a non-transitory storage medium may store data that can, over time, change (e.g., in Random Access Memory (RAM) or cache).

Although FIG. 3 shows various hardware components of the AMF entity (104) but it is to be understood that other embodiments are not limited thereon. In other embodiments, the AMF entity (104) may include less or more number of components. Further, the labels or names of the components are used only for illustrative purposes and does not limit the scope of the disclosure. One or more components can be combined together to perform the same or substantially similar function in the AMF entity (104).

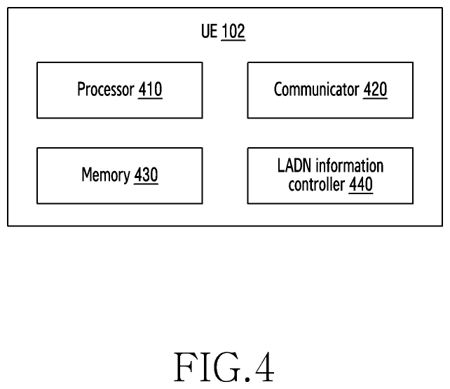

FIG. 4 shows various hardware components of the UE (102) according to an embodiment of the disclosure.

In an embodiment, the UE (102) includes a processor (410), a communicator (420), memory (430) and a LADN information controller (440). The processor (410) is coupled with the communicator (420), the memory (430) and the LADN information controller (440).

The LADN information controller (440) determines that the S-NSSAI is present in at least one of: the Partially Allowed NSSAI, and the allowed NSSAI. Further, the LADN information controller (440) obtains the LADN information for the S-NSSAI based on the determination.

The LADN information controller (440) obtains the capability support of the UE (102), where the capability support corresponds to receiving the LADN information. Further, the LADN information controller (440) sends the registration request message comprising the capability support to an AMF entity. Further, the LADN information controller (440) obtains the LADN information associated with the S-NSSAI from at least one of: the Partially Allowed NSSAI and the Allowed NSSAI based on the capability support of the UE (102).

In one embodiment, the LADN information controller (440) updates the LADN information when the S-NSSAI is removed from at least one of: the Partially Allowed NSSAI, and the allowed NSSAI. In an embodiment, the updating is done at locally at the UE (102) or receiving an explicit indication from the AMF entity (104).

The LADN information controller (440) detects at least one overlapping area between the LADN service area and the partial network slice support area. Further, the LADN information controller (440) gives the precedence the evaluation of the partial network slice support area over the evaluation of the LADN service area configured per DNN and S-NSSAI based on the detection. Further, the LADN information controller (440) evaluates the partial network slice support area before evaluating the LADN information configured per DNN and S-NSSAI for the at least one overlapping area.

The LADN information controller (440) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (410) may, for example, include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (410) may include multiple cores and is configured to execute the instructions stored in the memory (430).

Further, the processor (410) is configured to execute instructions stored in the memory (430) and to perform various processes. The communicator (420) is configured for communicating internally between internal hardware components and with external devices via one or more networks. The memory (430) also stores instructions to be executed by the processor (410). The memory (430) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. The memory (430) may, in some examples, be considered a non-transitory storage medium. The term “non-transitory” may indicate that the storage medium is not embodied in a carrier wave or a propagated signal. However, the term “non-transitory” should not be interpreted that the memory (430) is non-movable. In certain examples, a non-transitory storage medium may store data that can, over time, change (e.g., in Random Access Memory (RAM) or cache).

Although FIG. 4 shows various hardware components of the UE (102) but it is to be understood that other embodiments are not limited thereon. In other embodiments, the UE (102) may include less or more number of components. Further, the labels or names of the components are used only for illustrative purposes and does not limit the scope of the disclosure. One or more components can be combined together to perform the same or substantially similar function in the UE (102).

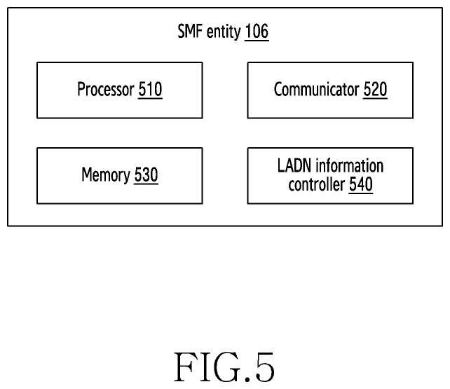

FIG. 5 shows various hardware components of the SMF entity (106) according to an embodiment of the disclosure.

The SMF entity (106) includes a processor (510), a communicator (520), memory (530) and a LADN information controller (540). The processor (510) is coupled with the communicator (520), the memory (530) and the LADN information controller (540).

The LADN information controller (540) detects, for example, at least one overlapping area between the LADN service area configured per DNN and S-NSSAI, and the Partial Network Slice Support Area. Further, the LADN information controller (540) gives precedence to the evaluation of the Partial Network Slice Support Area over the evaluation of the LADN service area configured per DNN and S-NSSAI in response to the at least one overlapping area. Further, the LADN information controller (540) evaluates the Partial Network Slice Support Area before the evaluation of the LADN service area configured per DNN and S-NSSAI in case of at least one overlapping area.

The LADN information controller (540) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (510) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (510) may include multiple cores and is configured to execute the instructions stored in the memory (530).

The processor (510) is configured to execute instructions stored in the memory (530) and to perform various processes. The communicator (520) is configured for communicating internally between internal hardware components and with external devices via one or more networks. The memory (530) also stores instructions to be executed by the processor (510). The memory (530) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (530) may, in some examples, be considered a non-transitory storage medium. The term “non-transitory” may indicate that the storage medium is not embodied in a carrier wave or a propagated signal. However, the term “non-transitory” should not be interpreted that the memory (530) is non-movable. In certain examples, a non-transitory storage medium may store data that can, over time, change (e.g., in Random Access Memory (RAM) or cache).

Although FIG. 5 shows various hardware components of the SMF entity (106) but it is to be understood that other embodiments are not limited thereon. In other embodiments, the SMF entity (106) may include less or more number of components. Further, the labels or names of the components are used only for illustrative purposes and does not limit the scope of the disclosure. One or more components can be combined together to perform the same or substantially similar function in the SMF entity (106).

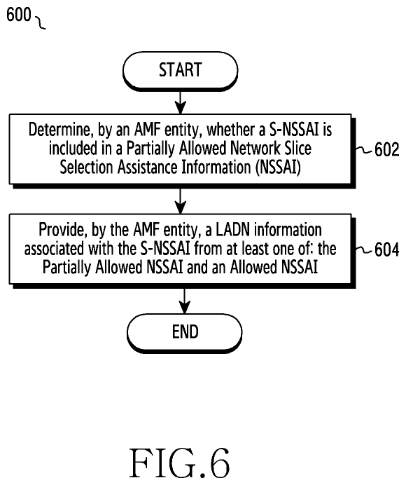

FIG. 6 is a flow chart (600) illustrating a method, implemented by the AMF entity (104), for handling the LADN service area in the wireless network (100) according to an embodiment of the disclosure.

The operations (602-604) are handled by the LADN information controller (340).

At operation 602, the method includes determining whether the S-NSSAI is included in the Partially Allowed NSSAI. At operation 604, the method includes providing the LADN information associated with the S-NSSAI from at least one of: the Partially Allowed NSSAI and an Allowed NSSAI.

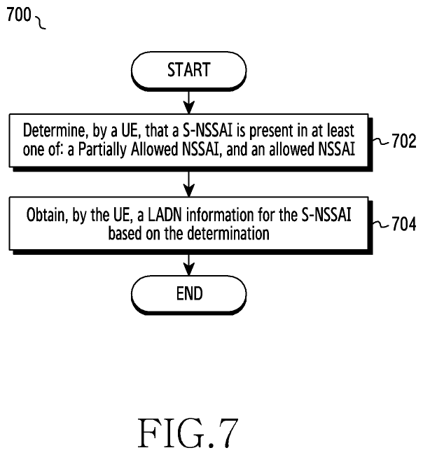

FIG. 7 is a flow chart (700) illustrating a method, implemented by the UE (102), for handling the LADN service area in the wireless network (100) according to an embodiment of the disclosure.

The operations (S702-S704) are handled by the LADN information controller (440).

At operation 702, the method includes determining that the S-NSSAI is present in at least one of: the Partially Allowed NSSAI, and the allowed NSSAI. At operation 704, the method includes obtaining the LADN information for the S-NSSAI based on the determination.

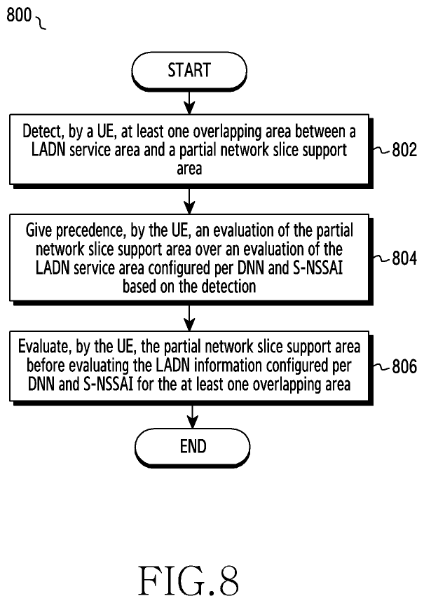

FIG. 8 is a flow chart (800) illustrating a method, implemented by the UE (102), for handling the LADN service area in the wireless network (100), when the UE (100) detects at least one overlapping area between the LADN service area and the partial network slice support area according to an embodiment of the disclosure.

The operations (S802-S806) are handled by the LADN information controller (440).

At operation 802, the method includes detecting the at least one overlapping area between the LADN service area and the partial network slice support area. At operation 804, the method includes giving precedence to the evaluation of the partial network slice support area over an evaluation of the LADN service area configured per DNN and S-NSSAI based on the detection. At operation 806, the method includes evaluating the partial network slice support area before evaluating the LADN information configured per DNN and S-NSSAI for the at least one overlapping area.

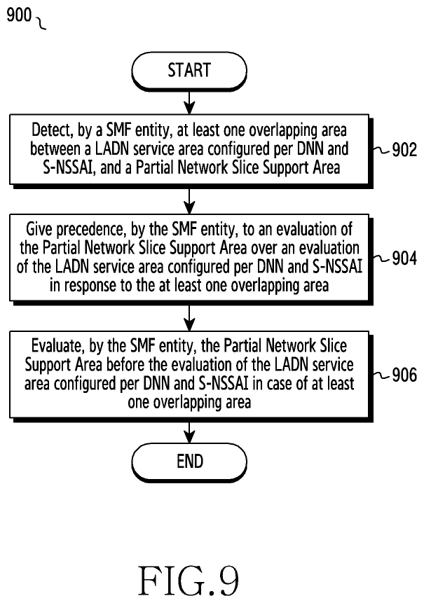

FIG. 9 is a flow chart (900) illustrating a method, implemented by the SMF entity (106), for handling the LADN service area in the wireless network (100) according to an embodiment of the disclosure.

The operations (S902-S906) are handled by the LADN information controller (540).

At operation 902, the method includes detecting the at least one overlapping area between the LADN service area configured per DNN and S-NSSAI, and the Partial Network Slice Support Area. At operation 904, the method includes giving precedence to an evaluation of the Partial Network Slice Support Area over an evaluation of the LADN service area configured per DNN and S-NSSAI in response to the at least one overlapping area. At operation 906, the method includes evaluating the Partial Network Slice Support Area before the evaluation of the LADN service area configured per DNN and S-NSSAI in case of at least one overlapping area.

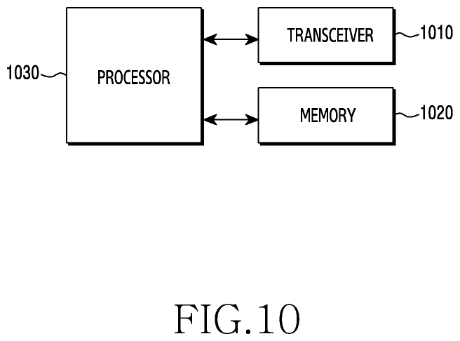

FIG. 10 shows various hardware components of a user equipment (UE) according to an embodiment of the disclosure.

As shown in FIG. 10, the UE according to an embodiment may include a transceiver 1010, a memory 1020, and a processor 1030. The transceiver 1010, the memory 1020, and the processor 1030 of the UE may operate according to a communication method of the UE described above. However, the components of the UE are not limited thereto. For example, the UE may include more or fewer components than those described above. In addition, the processor 1030, the transceiver 1010, and the memory 1020 may be implemented as a single chip. Also, the processor 1030 may include at least one processor. Furthermore, the UE of FIG. 10 may correspond to the UE of the FIG. 4.

The transceiver 1010 collectively refers to a UE receiver and a UE transmitter, and may transmit/receive a signal to/from a base station or a network entity. The signal transmitted or received to or from the base station or a network entity may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1030, a signal through a wireless channel, and transmit a signal output from the processor 1030 through the wireless channel.

The memory 1020 may store a program and data required for operations of the UE. Also, the memory 1020 may store control information or data included in a signal obtained by the UE. The memory 1020 may be a storage medium, such as read-only memory (ROM), random access memory (RAM), a hard disk, a CD-ROM, and a DVD, or a combination of storage media.

The processor 1030 may control a series of processes such that the UE operates as described above. For example, the transceiver 1010 may receive a data signal including a control signal transmitted by the base station or the network entity, and the processor 1030 may determine a result of receiving the control signal and the data signal transmitted by the base station or the network entity.

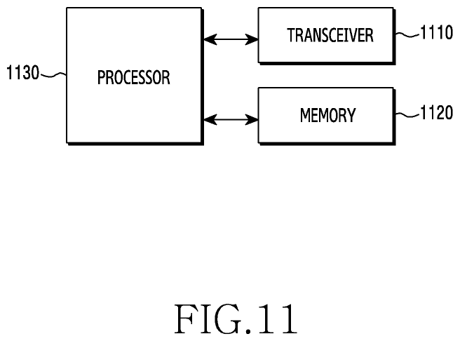

FIG. 11 shows various hardware components of a network entity according to an embodiment of the disclosure.

Referring to FIG. 11, the network entity includes a transceiver (1110), a memory (1120), and a processor (1130). The transceiver (1110), the memory (1120), and the processor (1130) of the network entity may operate according to a communication method of the network entity described above. However, the components of the network entity are not limited thereto. For example, the network entity may include fewer or a greater number of components than those described above. In addition, the processor (1130), the transceiver (1110), and the memory (1120) may be implemented as a single chip. Also, the processor (1130) may include at least one processor.

The network entity includes at least one entity of a core network. For example, the network entity includes an Access and mobility management function (AMF), a session management function (SMF), a policy control function (PCF), a network repository function (NRF), a user plane function (UPF), a network slicing selection function (NSSF), an authentication server function (AUSF), a unified data management (UDM) and a network exposure function (NEF), but the network entity is not limited thereto. For example, the network entity includes a user equipment (UE) or a base station (BS).

The transceiver (1110) collectively refers to a network entity receiver and a network entity transmitter, and may transmit/receive a signal to/from a base station or a UE. The signal transmitted or received to or from the base station or the UE may include control information and data. In this regard, the transceiver (1110) may include an RF transmitter for up-converting and amplifying a frequency of a transmitted signal, and an RF receiver for amplifying low-noise and down-converting a frequency of a received signal. However, this is only an example of the transceiver (1110) and components of the transceiver (1110) are not limited to the RF transmitter and the RF receiver.

The transceiver (1110) may receive and output, to the processor (1130), a signal through a wireless channel, and transmit a signal output from the processor (1130) through the wireless channel.

The memory (1120) may store a program and data required for operations of the network entity. Also, the memory (1120) may store control information or data included in a signal obtained by the network entity. The memory (1120) may be a storage medium, such as a ROM, a RAM, a hard disk, a CD-ROM, and a DVD, or a combination of storage media.

The processor (1130) may control a series of processes such that the network entity operates as described above. For example, the transceiver (1110) may receive a data signal including a control signal, and the processor (1130) may determine a result of receiving the data signal.

The various actions, acts, blocks, operations, or the like in the flow charts (600-900) may be performed in the order presented, in a different order or simultaneously. Further, in some embodiments, some of the actions, acts, blocks, operations, or the like may be omitted, added, modified, skipped, or the like without departing from the scope of the disclosure.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the scope of the embodiments as described herein.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an access and mobility management function (AMF) entity in a wireless communication system, the method comprising:
receiving, from a user equipment (UE), capability information indicating that the UE supports a local area data network (LADN) per data network name (DNN) and single network slice selection assistance information (S-NSSAI);
identifying an LADN service area for a DNN and an S-NSSAI; and
transmitting, to the UE, information on the DNN, information on the S-NSSAI, and information on the LADN service area.

2. The method of claim 1, wherein the LADN service area for the DNN and the S-NSSAI is based on a local configuration at the AMF entity.

3. The method of claim 1, wherein the LADN service area for the DNN and the S-NSSAI is based on subscription data from a unified data management (UDM) entity.

4. The method of claim 1, wherein the S-NSSAI and a tracking area identity (TA1) list associated with the S-NSSAI are included in a partially allowed NSSAI.

5. The method of claim 1,
wherein the capability information is received through a registration request message, and
wherein the information on the DNN, the information on the S-NSSAI, and the information on the LADN service area are transmitted through a registration accept message.

6. A method performed by a user equipment (UE) in a wireless communication system, the method comprising:
transmitting, to an access and mobility management function (AMF) entity, capability information indicating that the UE supports local area data network (LADN) per data network name (DNN) and single network slice selection assistance information (S-NSSAI); and
receiving, from the AMF entity, information on the DNN, information on the S-NSSAI, and information on the LADN service area.

7. The method of claim 6, wherein, in case that the UE has an overlapping area between the LADN service area and a partial network slice support area, an evaluation of the partial network slice support area takes precedence over an evaluation of the LADN service area.

8. The method of claim 6, wherein LADN service area for the DNN and the S-NSSAI is based on a local configuration at the AMF entity.

9. The method of claim 6, wherein the LADN service area for the DNN and the S-NSSAI is based on subscription data from a unified data management (UDM) entity.

10. The method of claim 6, wherein the S-NSSAI and a tracking area identity (TA1) list associated with the S-NSSAI are included in a partially allowed NSSAI.

11. An access and mobility management function (AMF) entity in a wireless communication system, the AMF entity comprising:
a transceiver; and
a controller coupled with the transceiver and configured to:
receive, from a user equipment (UE), capability information indicating that the UE supports a local area data network (LADN) per data network name (DNN) and single network slice selection assistance information (S-NSSAI),
identify an LADN service area for a DNN and an S-NSSAI, and
transmit, to the UE, information on the DNN, information on the S-NSSAI, and information on the LADN service area.

12. The AMF entity of claim 11, wherein the LADN service area for the DNN and the S-NSSAI is based on a local configuration at the AMF entity.

13. The AMF entity of claim 11, wherein the LADN service area for the DNN and the S-NSSAI is based on subscription data from a unified data management (UDM) entity.

14. The AMF entity of claim 11, wherein the S-NSSAI and a tracking area identity (TA1) list associated with the S-NSSAI are included in a partially allowed NSSAI.

15. The AMF entity of claim 11,
wherein the capability information is received through a registration request message, and
wherein the information on the DNN, the information on the S-NSSAI, and the information on the LADN service area are transmitted through a registration accept message.

16. A user equipment (UE) in a wireless communication system, the UE comprising:
a transceiver; and
a controller coupled with the transceiver and configured to:
transmit, to an access and mobility management function (AMF) entity, capability information indicating that the UE supports local area data network (LADN) per data network name (DNN) and single network slice selection assistance information (S-NSSAI), and
receive, from the AMF entity, information on the DNN, information on the S-NSSAI, and information on the LADN service area.

17. The UE of claim 16, wherein, in case that the UE has an overlapping area between the LADN service area and a partial network slice support area, an evaluation of the partial network slice support area takes precedence over an evaluation of the LADN service area.

18. The UE of claim 16, wherein LADN service area for the DNN and the S-NSSAI is based on a local configuration at the AMF entity.

19. The UE of claim 16, wherein the LADN service area for the DNN and the S-NSSAI is based on subscription data from a unified data management (UDM) entity.

20. The UE of claim 16, wherein the S-NSSAI and a tracking area identity (TA1) list associated with the S-NSSAI are included in a partially allowed NSSAI.
